(19) United States
(12) Patent Application Publication
(10) Pub. No.: US 2021/0394130 A1
(43) Pub. Date: Dec. 23, 2021

(54) System and Method for Making a Saltwater Solution for Electrolysis

(71) Applicants: Hien Tu Le, Happy Valley, OR (US); Gia Thanh Le, Happy Valley, OR (US); Joseph Tu Le, Happy Valley, OR (US)

(72) Inventors: Hien Tu Le, Happy Valley, OR (US); Gia Thanh Le, Happy Valley, OR (US); Joseph Tu Le, Happy Valley, OR (US)

(21) Appl. No.: 17/351,708

(22) Filed: Jun. 18, 2021

Related U.S. Application Data
(63) Continuation-in-part of application No. 17/217,958, filed on Mar. 30, 2021.
(60) Provisional application No. 63/041,626, filed on Jun. 19, 2020.
(60) Provisional application No. 63/054,708, filed on Jul. 21, 2020.

(51) Int. Cl. B01F 1/00

(52) U.S. Cl. CPC B01F 1/0038; B01F 2001/0088; B01F 2001/0044; B01F 1/0005

(57) ABSTRACT

A system and a method make a saltwater solution for electrolysis through the process of flowing water through a salt chamber to dissolve salt crystals and outputting the resulting saltwater solution into a saltwater container. The system includes a salt chamber, a remaining quantity of salt crystals, a filter, and a saltwater container. The salt chamber is a chamber that contains the remaining quantity of salt crystals. The salt chamber and the saltwater container are in fluid communication with each other, and thus, the saltwater container can receive the resulting saltwater solution. The salt chamber includes a chamber inlet and a chamber outlet. The filter is connected across the chamber outlet in order to retain undissolved salt crystals within the salt chamber.

The current application claims a priority to a U.S. non-provisional application Ser. No. 17/217,958 filed on Mar. 30, 2021. The U.S. non-provisional application Ser. No. 17/217,958 claims a priority to the U.S. Provisional Patent application Ser. No. 63/041,626 filed on Jun. 19, 2020.

The current application also claims a priority to the U.S. Provisional Patent application Ser. No. 63/054,708 filed on Jul. 21, 2020.

### FIELD OF THE INVENTION

The present invention relates generally to methods of making saltwater solution. More specifically, the present invention is a method that flows water through a salt chamber to dissolve and mix a quantity of salt crystals into a saltwater solution.

### BACKGROUND OF THE INVENTION

Electrolysis using a saltwater solution usually involves a very low concentration of salt; however, most systems on the market utilize a saturated saltwater solutions then dilute the saltwater solution with fresh water as it goes through the system. Saturated saltwater solutions normally are made using crystalized salts placed in a solvent solution, usually water. The crystalized salt is then constantly or intermittently mixed in the solvent solution over long durations, up to a few hours. It is especially hard to dissolve the last few percent to achieve saturation. Dissolving a low concentration of salt in a still container of water requires vigorous stirring to completely dissolve the salt crystals. There exists a need for a better method to make a saltwater solution for electrolysis.

It is therefore an objective of the present invention to provide a system and method of mixing a quantity of salt crystals integrated in a salt chamber with a direct flow of running water. The method of the present invention dissolves the quantity of salt crystals in the salt chamber while filling a saltwater container. With the low concentration requirement of salt associated with electrolysis, the quantity of salt crystals in the salt chamber would be long dissolved by the time the saltwater container is filled. Putting the measured amount of salt crystals in the salt chamber yields a desired concentration of salt by the time the saltwater container is filled to a target volume.

### BRIEF DESCRIPTION OF THE DRAWINGS

FIG. 1 is a block diagram illustrating the overall system of the present invention.

FIG. 2 is a perspective view of the salt chamber.

FIG. 3 is a flowchart illustrating the overall process of the present invention.

FIG. 4 is a flowchart illustrating the subprocess of recycling the quantity of water-based solvent to make a saturated saltwater solution.

FIG. 5 is flowchart illustrating the subprocess of using the external water source as the water-based solvent in the initial iteration.

FIG. 6 is a flowchart illustrating the subprocess of using the quantity of saltwater solution from the container drain as the water-based solvent in following iterations.

FIG. 7 is a flowchart illustrating the subprocess of using a flowmeter to efficiently fill the saltwater container.

FIG. 8 is a diagram illustrating an exemplary embodiment of the present invention including the external water source, the diversion valve, the flowmeter, and the container drain.

### DETAIL DESCRIPTIONS OF THE INVENTION

All illustrations of the drawings are for the purpose of describing selected versions of the present invention and are not intended to limit the scope of the present invention.

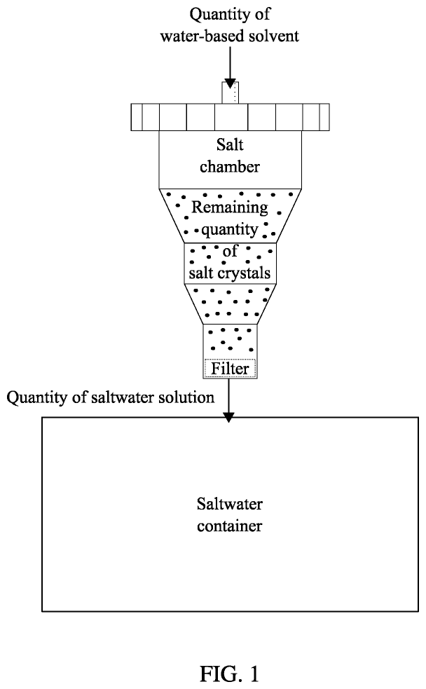

In reference to FIGS. 1 through 8, the present invention is a system and method for making a saltwater solution for electrolysis through the process of flowing water through a salt chamber to dissolve salt crystals and outputting the resulting saltwater solution into a saltwater container. The system of the present invention includes a salt chamber, a remaining quantity of salt crystals, a filter, and a saltwater container (Step A). The salt chamber is a chamber that contains the remaining quantity of salt crystals. The salt chamber and the saltwater container are in fluid communication with each other, and thus, the saltwater container can receive a resulting saltwater solution from the salt chamber. The salt chamber includes a chamber inlet and a chamber outlet. The filter is connected across the chamber outlet in order to retain undissolved salt crystals within the salt chamber.

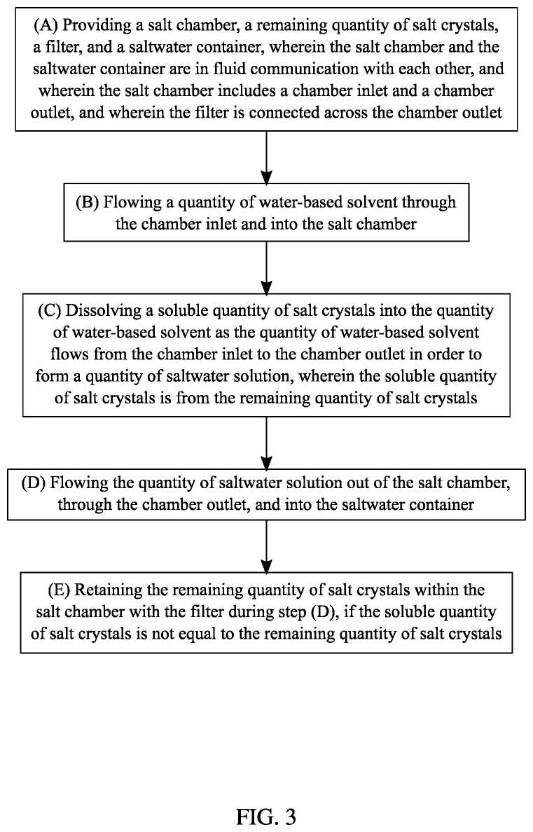

In reference to FIG. 3, the method of the present invention follows an overall process for making a saltwater solution for electrolysis. A quantity of water-based solvent flows through the chamber inlet and into the salt chamber (Step B). The quantity of water-based solvent is preferably water as it first flows into the salt chamber. A soluble quantity of salt crystals is dissolved into the quantity of water-based solvent as the quantity of water-based solvent flows from the chamber inlet to the chamber outlet in order to form a quantity of saltwater solution (Step C). The soluble quantity of salt crystals is from the remaining quantity of salt crystals. Moreover, the soluble quantity of salt crystals is a set of salt crystals which are dissolved as the water-based solvent flows through the salt chamber. The quantity of saltwater solution flows out of the salt chamber, through the chamber outlet, and into the saltwater container (Step D). Thus, the saltwater container receives the saltwater solution to be used for electrolysis. Additionally, the remaining quantity of salt crystals is retained within the salt chamber with the filter during Step D, if the soluble quantity of salt crystals is not equal to the remaining quantity of salt crystals (Step E). Thus, a low amount of salt concentration is achieved by preventing undissolved salt crystals from flowing into the saltwater solution.

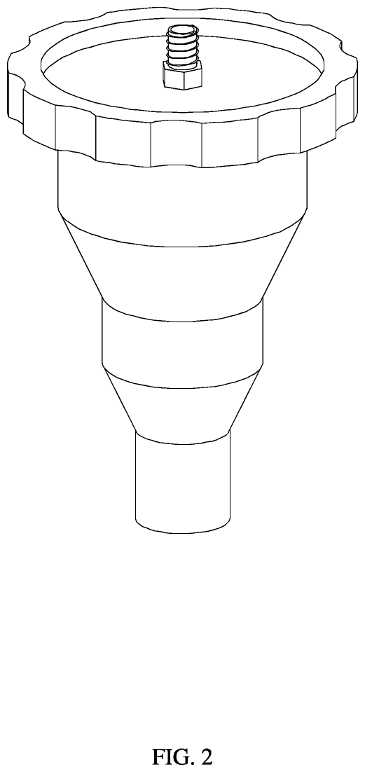

With reference to FIG. 2, the design of the salt chamber allows the soluble quantity of salt crystals to quickly dissolve as the water-based solvent flows through the salt chamber. More specifically, the salt chamber further includes a lateral chamber body, wherein the lateral chamber body is shaped with a tiered taper from the chamber inlet to the chamber outlet. This design speeds up the flow of the water-based solvent as it flows from the chamber inlet to the chamber outlet. Moreover, the design of the salt chamber allows for a fluid conduit to be connected in order to establish the fluid communication for the water-based solvent. In more detail, the salt chamber further includes a hose attachment mechanism, wherein the hose attachment mechanism is integrated into the chamber inlet. Thus, a hose or similar fluid conduit can be attached to the salt chamber in order to establish the fluid communication for the water-based solvent.

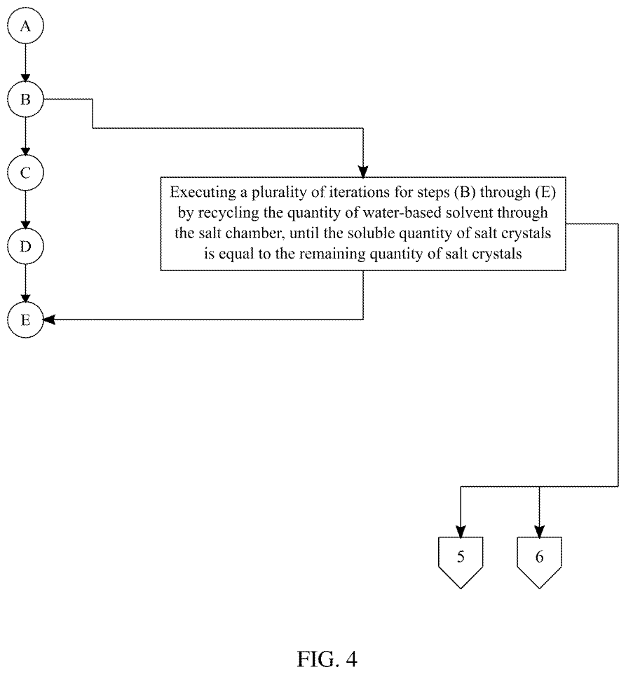

Ideally, the objective of the present invention is to make a saturated saltwater solution by dissolving all the salt crystals in one iteration. However, this may not occur and thus, in order to dissolve all the salt crystals and with reference to FIG. 4, a plurality of iterations is executed for Steps B through E by recycling the quantity of water-based solvent through the salt chamber, until the soluble quantity of salt crystals is equal to the remaining quantity of salt crystals. Thus, the water-based solvent is flowed through the salt chamber until all the salt crystals are dissolved in order to make a saturated saltwater solution.

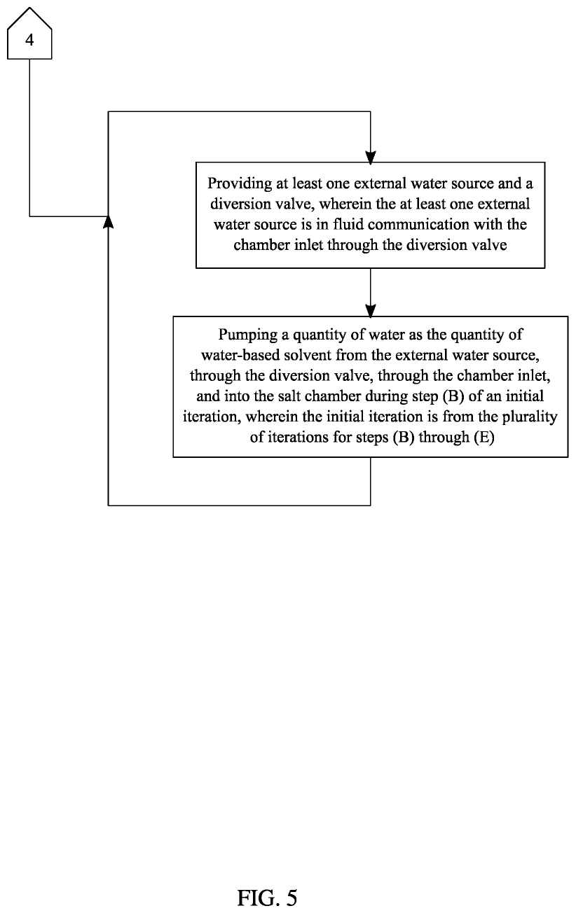

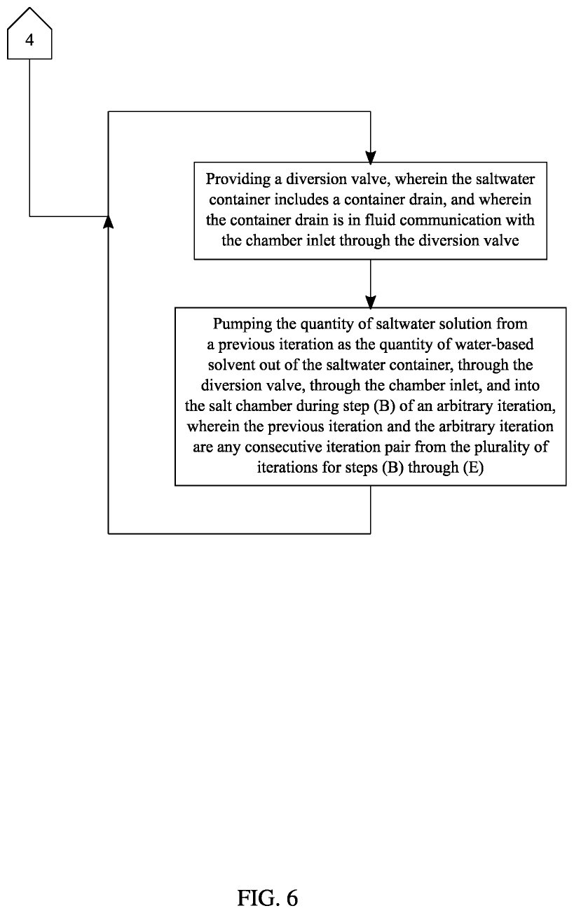

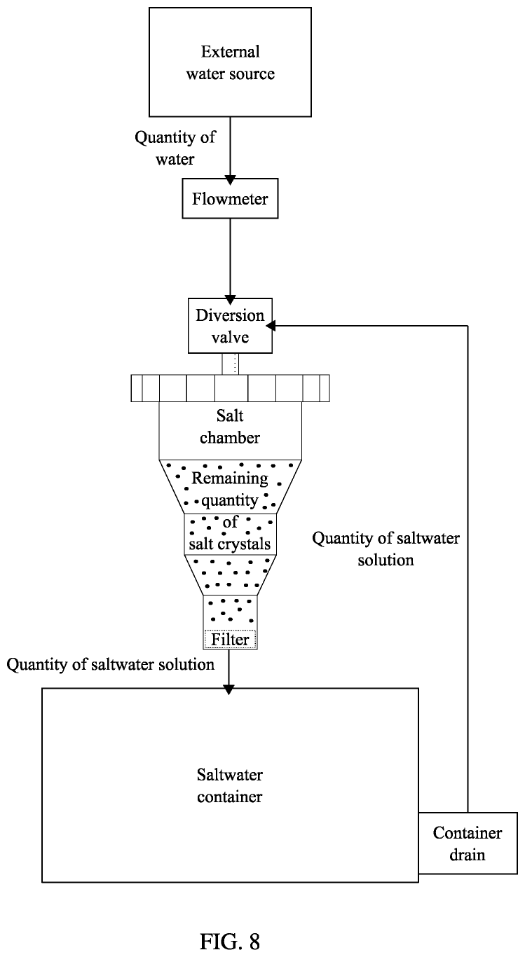

With reference to FIGS. 5 and 8, the system of the present invention may further include at least one external water source and a diversion valve for the initial iteration for Step B. The at least one external water source is in fluid communication with the chamber inlet through the diversion valve. The at least one external water source may be any water source. For example, the at least one external water source may be a municipality water tap or a pressurized water source. The diversion valve is used to control the flow from the at least one external water source. A quantity of water as the quantity of water-based solvent is pumped from the external water source, through the diversion valve, through the chamber inlet, and into the salt chamber during Step B of an initial iteration, wherein the initial iteration is from the plurality of iterations for Steps B through E. Thus, the quantity of water is first flowed into the salt chamber from the external water source in order to produce a saltwater solution. For the following iterations for Steps B through E and with reference to FIGS. 6 and 8, the saltwater container includes a container drain, and the container drain is in fluid communication with chamber inlet through the diversion valve. Thus, the diversion valve can control if the quantity of water-based solvent flows from the external water source or from the container drain. The quantity of saltwater solution from a previous iteration as the quantity of water-based solvent is pumped out of the saltwater container, through the diversion valve, through the chamber inlet, and into the salt chamber during Step B of an arbitrary iteration, wherein the previous iteration and the arbitrary iteration are any consecutive iteration pair of the plurality of iterations for Steps B through E. Thus, the diversion valve stops the flow from the external water source after the initial iteration, and the resulting quantity of saltwater solution is flowed through the salt chamber until all the salt crystals are dissolved in order to produce a saturated saltwater solution.

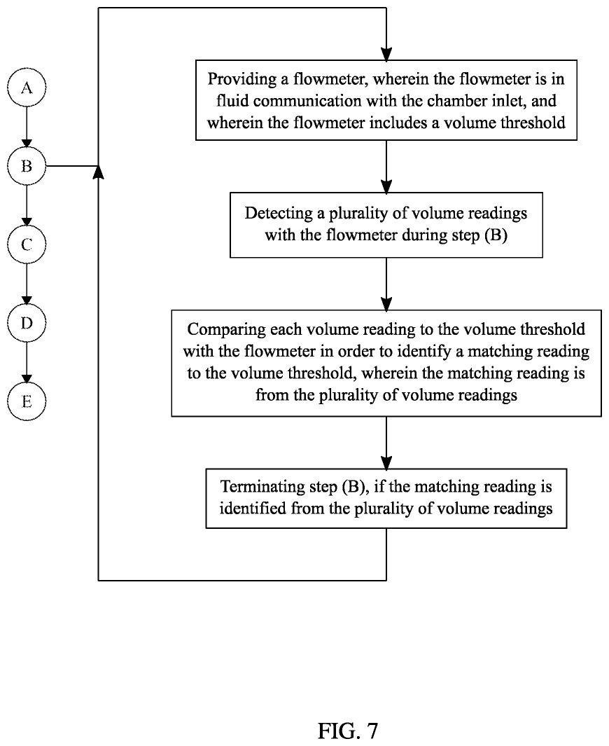

In order to determine when the saltwater container is efficiently filled with the quantity of saltwater solution and with reference to FIGS. 7 and 8, the system of the present invention may further include a flowmeter. The flowmeter is in fluid communication with the chamber inlet and includes a volume threshold. More specifically, the flowmeter establishes the fluid communication between the external water source and the diversion valve. The flowmeter detects a plurality of volume readings during Step B. The plurality of volume readings is a set of volume measurements that are read by the flowmeter as the quantity of water flows from the external water source. The flowmeter compares each volume reading to the volume threshold in order to identify a matching reading to the volume threshold, wherein the matching reading is from the plurality of volume readings. The matching reading is the reading that identifies the efficient volume of the quantity of saltwater solution to fill the saltwater container. Step B is terminated, if the matching reading is identified from the plurality of volume readings. In more detail, the diversion valve stops the flow of the quantity of water from the external water source in the initial iteration once the saltwater container is efficiently filled with the quantity of saltwater solution.

Although the invention has been explained in relation to its preferred embodiment, it is to be understood that many other possible modifications and variations can be made without departing from the spirit and scope of the invention as hereinafter claimed.

What is claimed is:

1. A method for making a saltwater solution for electrolysis, the method comprising the steps of:
(A) providing a salt chamber, a remaining quantity of salt crystals, a filter, and a saltwater container, wherein the salt chamber and the saltwater container are in fluid communication with each other, and wherein the salt chamber includes a chamber inlet and a chamber outlet, and wherein the filter is connected across the chamber outlet;
(B) flowing a quantity of water-based solvent through the chamber inlet and into the salt chamber;
(C) dissolving a soluble quantity of salt crystals into the quantity of water-based solvent as the quantity of water-based solvent flows from the chamber inlet to the chamber outlet in order to form a quantity of saltwater solution, wherein the soluble quantity of salt crystals is from the remaining quantity of salt crystals;
(D) flowing the quantity of saltwater solution out of the salt chamber, through the chamber outlet, and into the saltwater container; and
(E) retaining the remaining quantity of salt crystals within the salt chamber with the filter during step (D), if the soluble quantity of salt crystals is not equal to the remaining quantity of salt crystals.

2. The method as claimed in claim 1, wherein the salt chamber further includes a lateral chamber body, and wherein the lateral chamber body is shaped with a tiered taper from the chamber inlet to the chamber outlet.

3. The method as claimed in claim 1, wherein the salt chamber further includes a hose attachment mechanism, and wherein the hose attachment mechanism is integrated into the chamber inlet.

4. The method as claimed in claim 1, the method comprising the steps of:
executing a plurality of iterations for steps (B) through (E) by recycling the quantity of water-based solvent through the salt chamber, until the soluble quantity of salt crystals is equal to the remaining quantity of salt crystals.

5. The method as claimed in claim 4, the method comprising the steps of:
providing at least one external water source and a diversion valve, wherein the at least one external water source is in fluid communication with the chamber inlet through the diversion valve; and
pumping a quantity of water as the quantity of water-based solvent from the external water source, through the diversion valve, through the chamber inlet, and into the salt chamber during step (B) of an initial iteration, wherein the initial iteration is from the plurality of iterations for steps (B) through (E).

6. The method as claimed in claim 5, wherein the external water source is a municipality water tap.

7. The method as claimed in claim 5, wherein the external water source is a pressurized water source.

8. The method as claimed in claim 4, the method comprising the steps of:
providing a diversion valve, wherein the saltwater container includes a container drain, and wherein the container drain is in fluid communication with the chamber inlet through the diversion valve; and
pumping the quantity of saltwater solution from a previous iteration as the quantity of water-based solvent out of the saltwater container, through the diversion valve, through the chamber inlet, and into the salt chamber during step (B) of an arbitrary iteration, wherein the previous iteration and the arbitrary iteration are any consecutive iteration pair from the plurality of iterations for steps (B) through (E).

9. The method as claimed in claim 1, the method comprising the steps of:
providing a flowmeter, wherein the flowmeter is in fluid communication with the chamber inlet, and wherein the flowmeter includes a volume threshold;
detecting a plurality of volume readings with the flowmeter during step (B);
comparing each volume reading to the volume threshold with the flowmeter in order to identify a matching reading to the volume threshold, wherein the matching reading is from the plurality of volume readings; and
terminating step (B), if the matching reading is identified from the plurality of volume readings.
